(19) United States
(12) Patent Application Publication
(10) Pub. No.: US 2006/0126440 A1
(43) Pub. Date: Jun. 15, 2006

(54) Square shaped timepieces with transparent views

(76) Inventor: Daniel Lazaretnik, New York, NY (US)

Correspondence Address: OSTROLENK FABER GERB & SOFFEN, 1180 AVENUE OF THE AMERICAS, NEW YORK, NY, 100368403, US

(21) Appl. No.: 11/273,444

(22) Filed: Nov. 14, 2005

Related U.S. Application Data
(63) Continuation-in-part of application No. 10/821,449, filed on Apr. 8, 2004.
Application No. 10/821,449 is a continuation-in-part of application No. 10/783,300, filed on Feb. 20, 2004.

(51) Int. Cl. G04C 23/02

(52) U.S. Cl. 368/88

(57) ABSTRACT

The present invention is, generally, a timepiece comprising a substantially square-shaped dial face having a boundary surrounding the dial face. Further, a single series of hours indicia are arranged along and following the boundary and surrounding an interior region of the dial face. The invention further comprises a time movement including respective hour and minute handles, a detachable substantially square-shaped bezel, and a plurality of windows that enable the viewing of the interior region of the dial face from respective viewing angles.

### CROSS-REFERENCE TO RELATED APPLICATIONS

The present application is a continuation-in-part of U.S. patent application Ser. No. 10/821,449, filed on Apr. 8, 2004 and entitled “OVAL SHAPED TIMEPIECES AND STEM ARRANGEMENT FOR WATCHES,” which is a continuation-in-part of U.S. patent application Ser. No. 10/783,300, filed Feb. 20, 2004 and entitled “OVAL SHAPED TIMEPIECES AND STEM ARRANGEMENT FOR WATCHES,” the entire contents of all of which are expressly incorporated herein by reference.

### BACKGROUND OF THE INVENTION

The present invention relates to timepieces and, more particularly, to an analog or analog-style watch employing a single dial face having a single series of hours indicia.

The art of watchmaking and designing is a highly developed art which has progressed over hundreds of years. Therefore, creating a watch's timekeeping movements, whether implemented entirely mechanically, or as a combination of electronic circuitry and mechanical parts, is widely known and within easy reach of a person of ordinary skill in the art and, as such, does not require further explanation herein.

The marketing and promotion of various timepieces are therefore driven by appearance and design aspects, as well as various add-on functionality of watches, by which manufacturers and suppliers of watches distinguish their wares from one another.

### SUMMARY OF THE INVENTION

Accordingly, it is an object of the present invention to provide a novel chronometer and/or chronograph watch of unique functionality and arrangement.

The present invention is, generally, a timepiece comprising a substantially square-shaped dial face having a boundary surrounding the dial face. Further, a single series of hours indicia are arranged along and following the boundary and surrounding an interior region of the dial face. The invention further comprises a time movement including respective hour and minute handles, a detachable substantially square-shaped bezel, and a plurality of windows that enable the viewing of the interior region of the dial face from respective viewing angles.

Other features and advantages of the present invention will become apparent from the following description of the invention which refers to the accompanying drawings.

### BRIEF DESCRIPTION OF THE DRAWINGS

FIG. 1A illustrates an example dial face that includes stylistic series of hours indicia only includes the numerals, twelve, three, six and nine.

FIGS. 1B and 1C illustrate slight variations of hours indicia, referred to, generally, herein as dial flower numbers.

FIGS. 2A and 2B comprise an exploded view and corresponding table of components of an example embodiment of the present invention.

FIGS. 3A and 3B are schematic diagrams illustrating a watch body in accordance with a preferred embodiment.

FIGS. 4A and 4B are schematic diagrams illustrating a watch body in accordance with a preferred embodiment.

FIG. 5 is a schematic diagram illustrating the dial face of a preferred embodiment of the present invention, and further comprises a power reserve indicator.

FIG. 6A shows a right elevational view of a preferred embodiment.

FIG. 6B is a right perspective view of the preferred embodiment shown in FIG. 6A.

FIG. 6C is a front elevational view of the embodiment shown in FIG. 6A.

FIG. 6D is another front elevational view of the embodiment shown in FIG. 6A.

FIGS. 6E-6L illustrate the embodiment shown in FIG. 6A, and include various perspectives and angles, as will be apparent to one skilled in the art.

### DETAILED DESCRIPTION OF PREFERRED EMBODIMENTS OF THE INVENTION

The present invention comprises a timepiece with a plurality of windows that enable the viewing of time movements and/or the inner workings of the timepiece.

Preferably, the timepiece of the present invention comprises a body structure that appeals to consumers who prefer a heavy and bulky watch, such as approximately three hundred grams. As known to those skilled in the art, such a body structure connotes power and prestige to the wearer.

In one embodiment, the present invention comprises a novel chronometer and/or chronograph watch of unique functionality and arrangement.

In a preferred embodiment, the watch of the present invention comprises a removable bezel, such as described in U.S. patent application Ser. No. 10/821,449. Preferably, the watch of the present invention is substantially square-shaped.

It is envisioned herein that the present invention can be provided in many embodiments, for example, the invention may comprises a dial face that includes a view representing an amount of available remaining power. The available power may relate to battery power, or in case of a self-winding watch, the amount of power left before the watch stops running.

In an alternative embodiment, the dial face may comprise multiple dials, each displaying the time in a respective timezone.

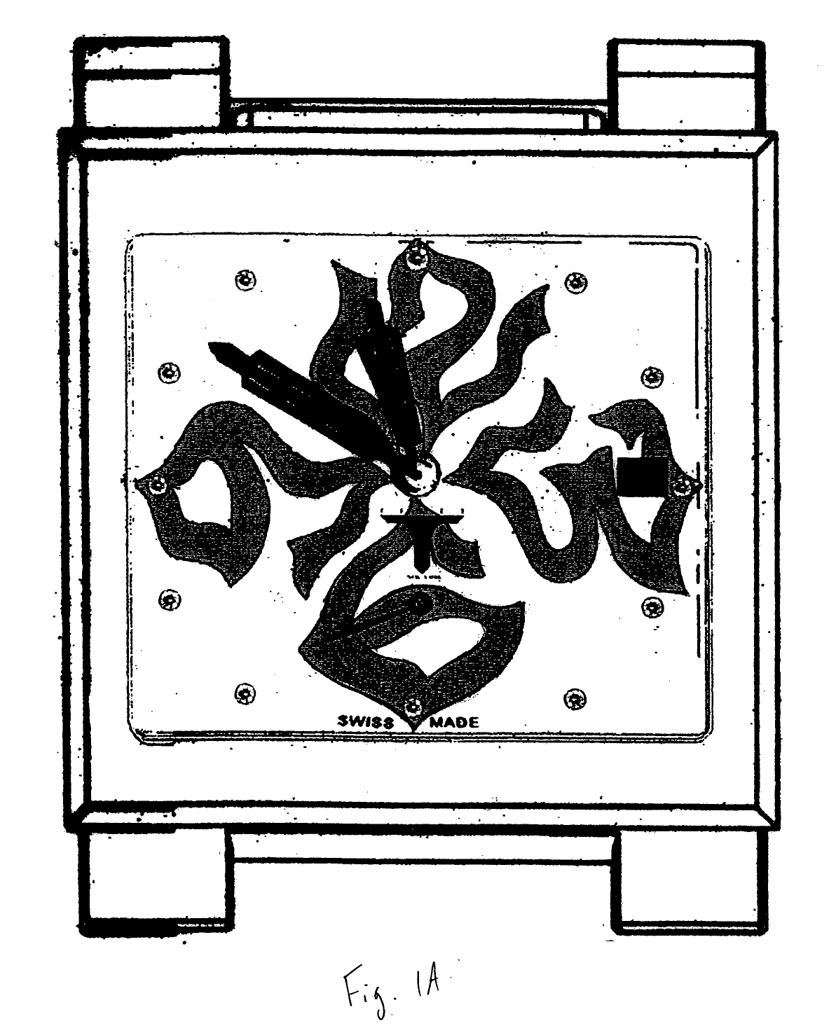

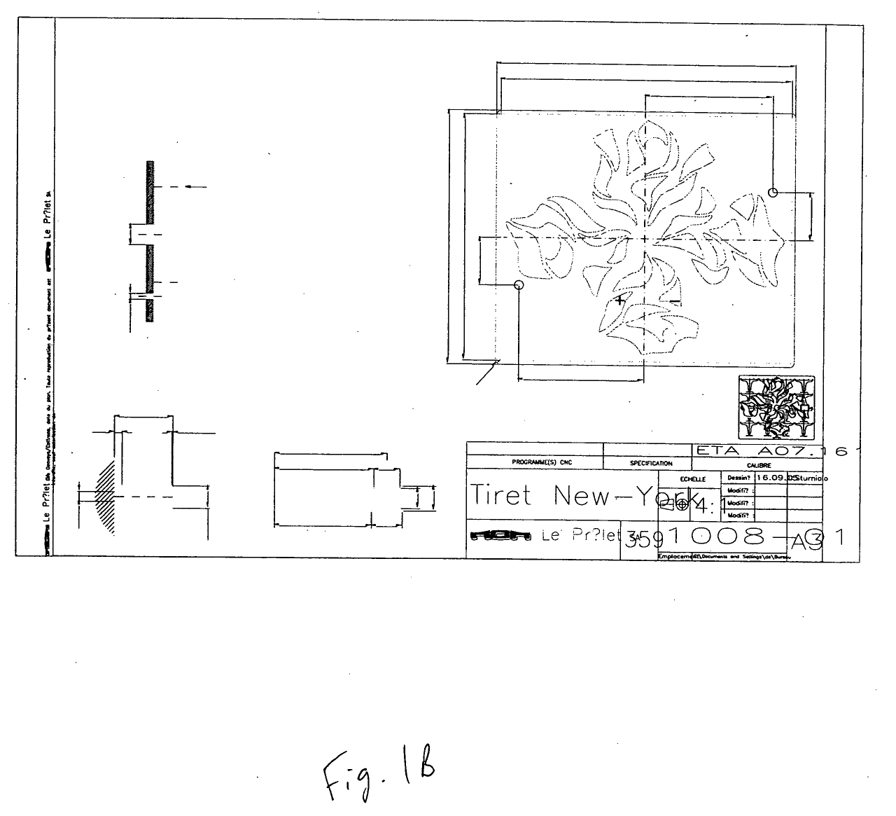

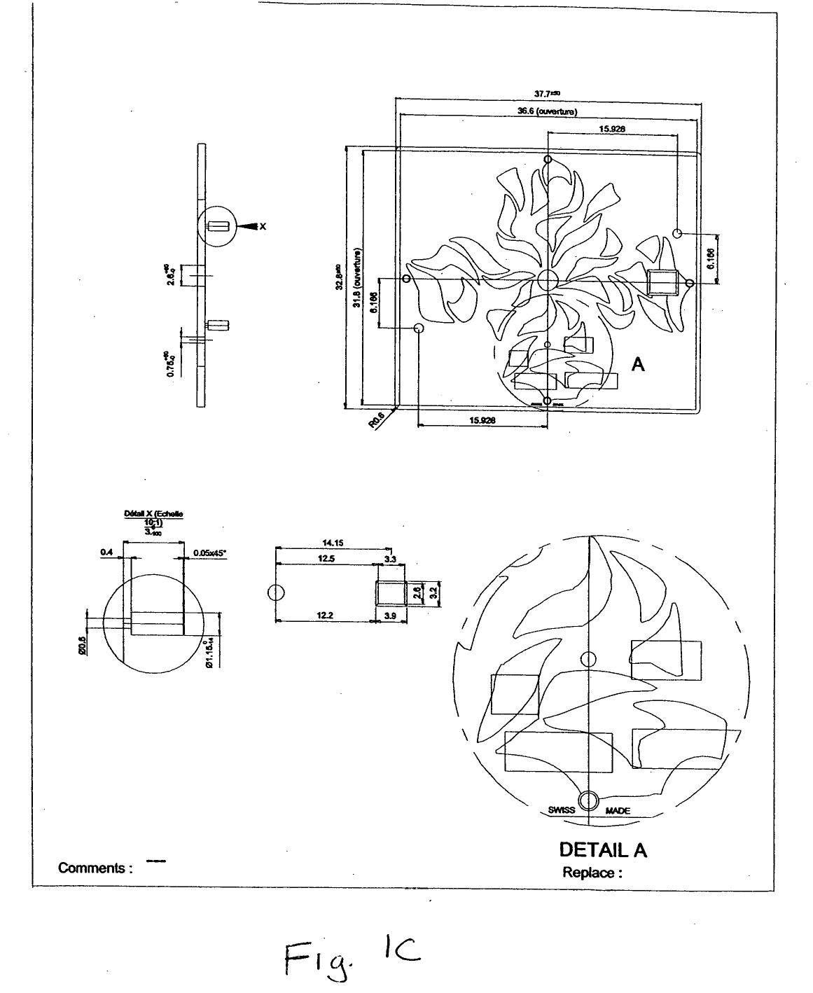

FIG. 1A illustrates an example dial face that includes stylistic series of hours indicia only includes the numerals, twelve, three, six and nine. Also the embodiment shown in FIG. 1A is adorned with precious or semiprecious stones, and comprises a remaining power indicator, as well as an hour indicator and a minute indicator.

Thus, a single series of hours indicia is preferably arranged around and along the boundary of dial face and surrounds an interior region of dial face. The series of hour indicia may include fluorescent ink for visibility in the dark.

FIGS. 1B and 1C illustrate slight variations of hours indicia, referred to, generally, herein as dial flower numbers.

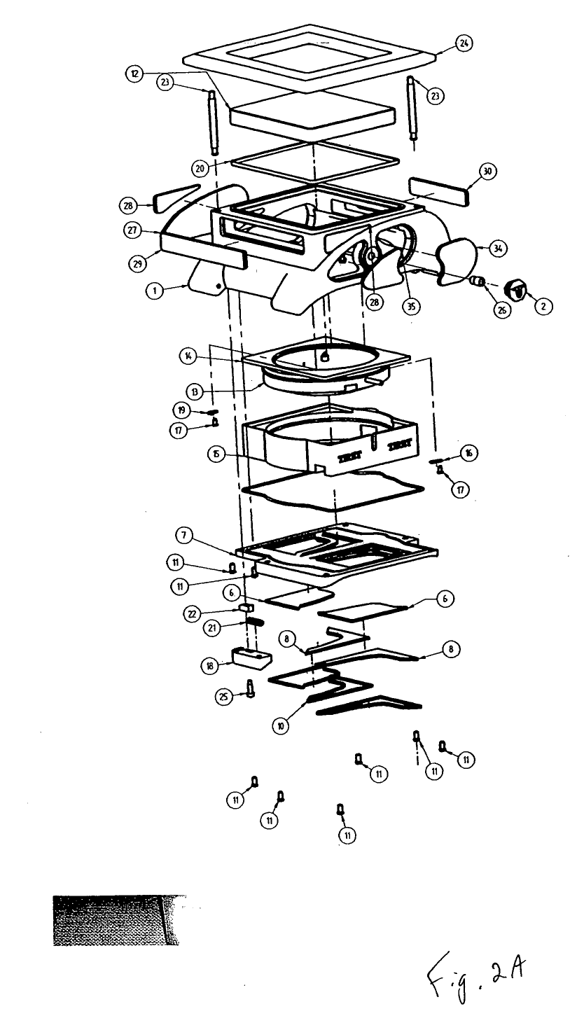

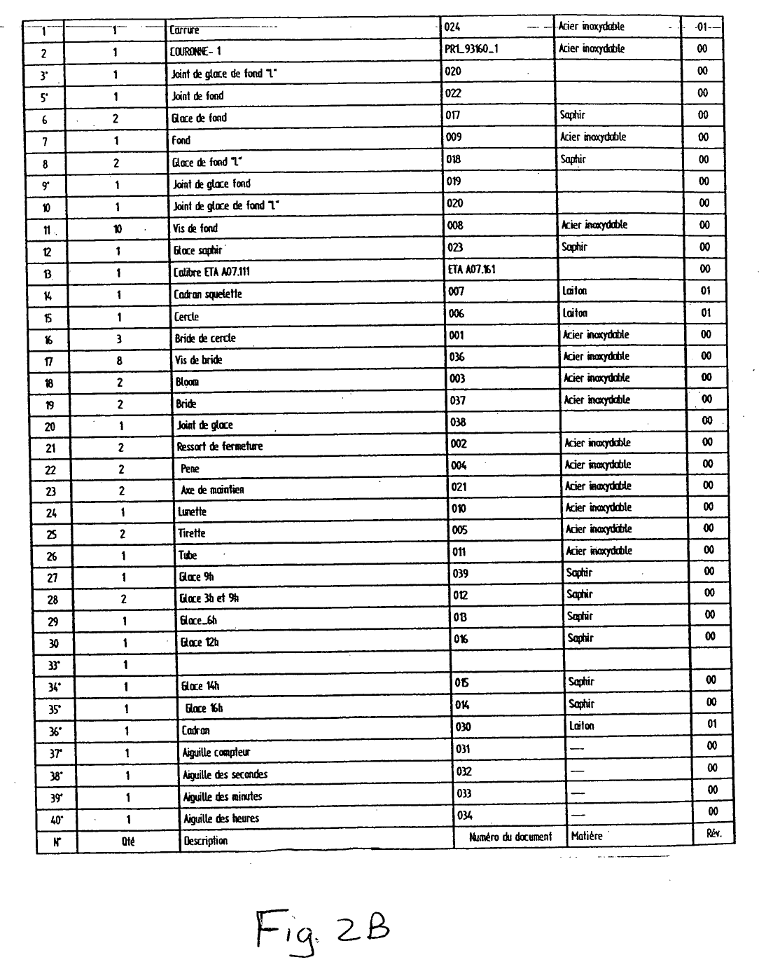

FIGS. 2A and 2B comprise an exploded view and corresponding table of components of an example embodiment of the present invention. The elements of the body of a watch in accordance with a preferred embodiment are illustrated, thereby providing for holding the movements of the watch, the dial face, bezel and related components. FIG. 2B is a table identifying the elements illustrated in FIG. 2A.

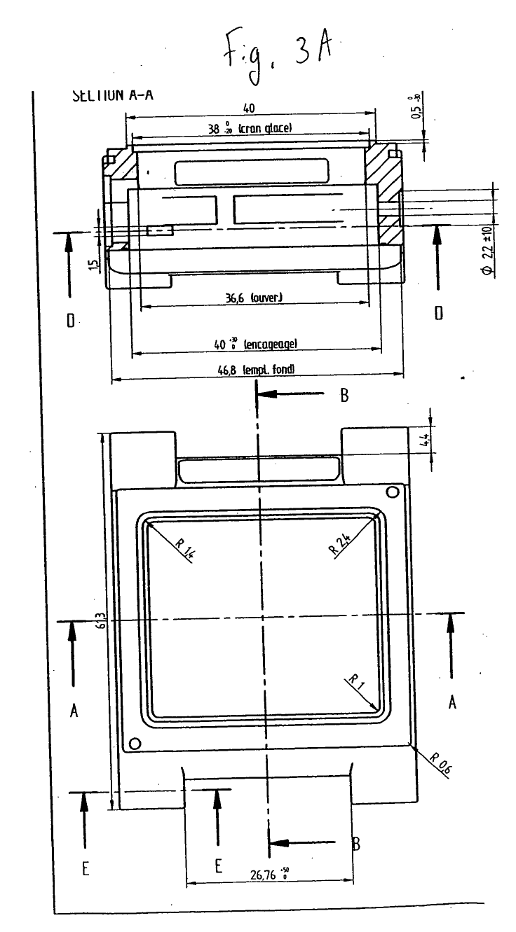

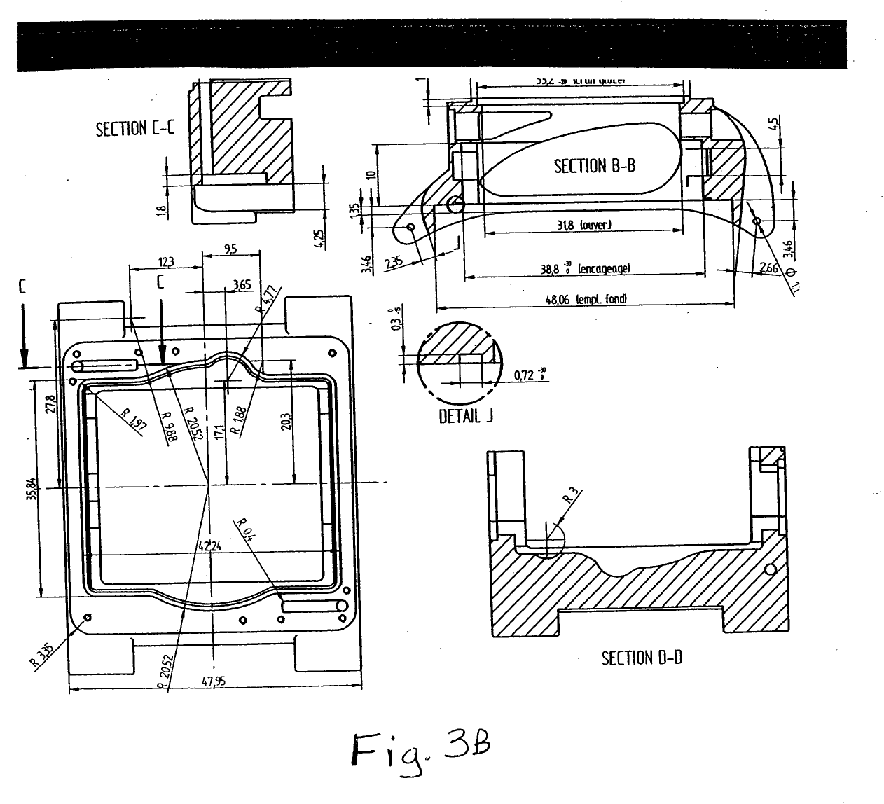

FIGS. 3A and 3B are schematic diagrams illustrating a watch body in accordance with a preferred embodiment.

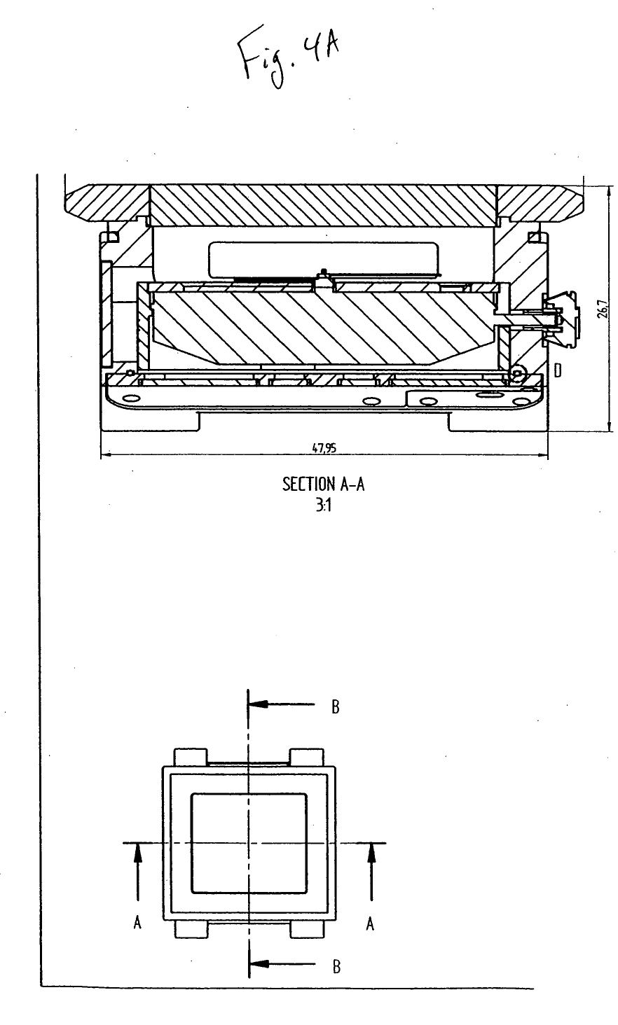

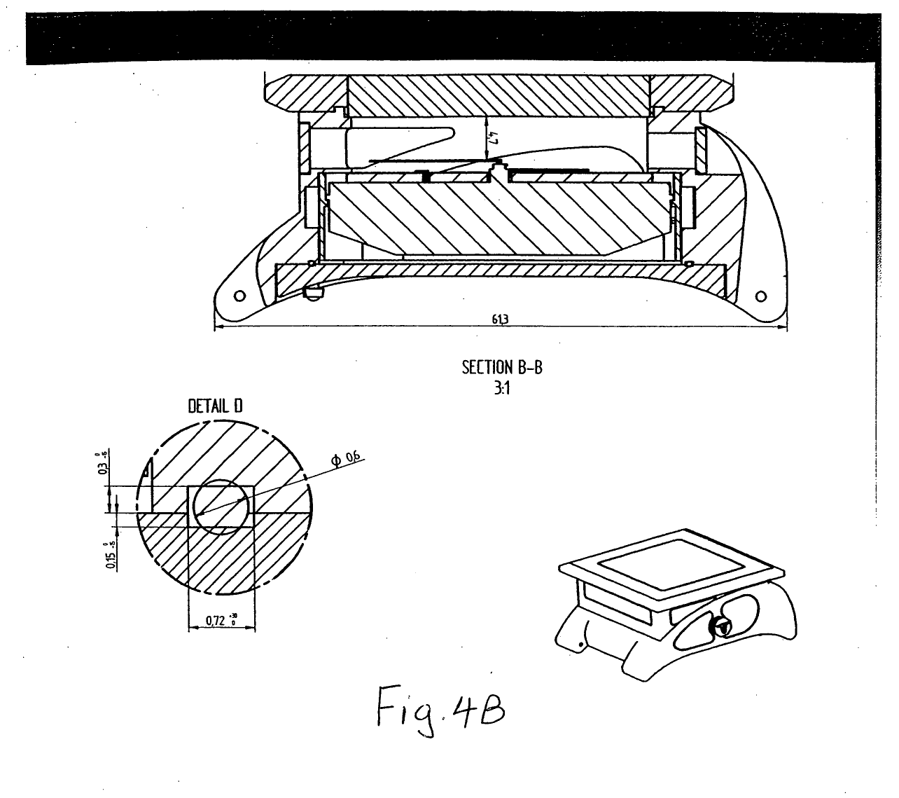

FIGS. 4A and 4B are schematic diagrams illustrating a watch body in accordance with a preferred embodiment.

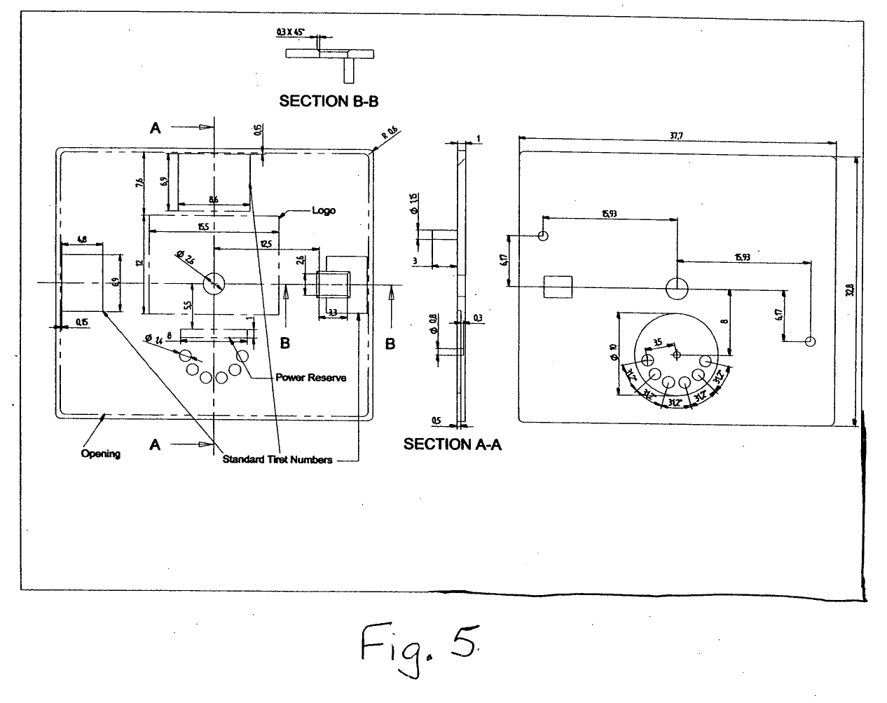

FIG. 5 is a schematic diagram illustrating the dial face of a preferred embodiment of the present invention, and further comprises a power reserve indicator.

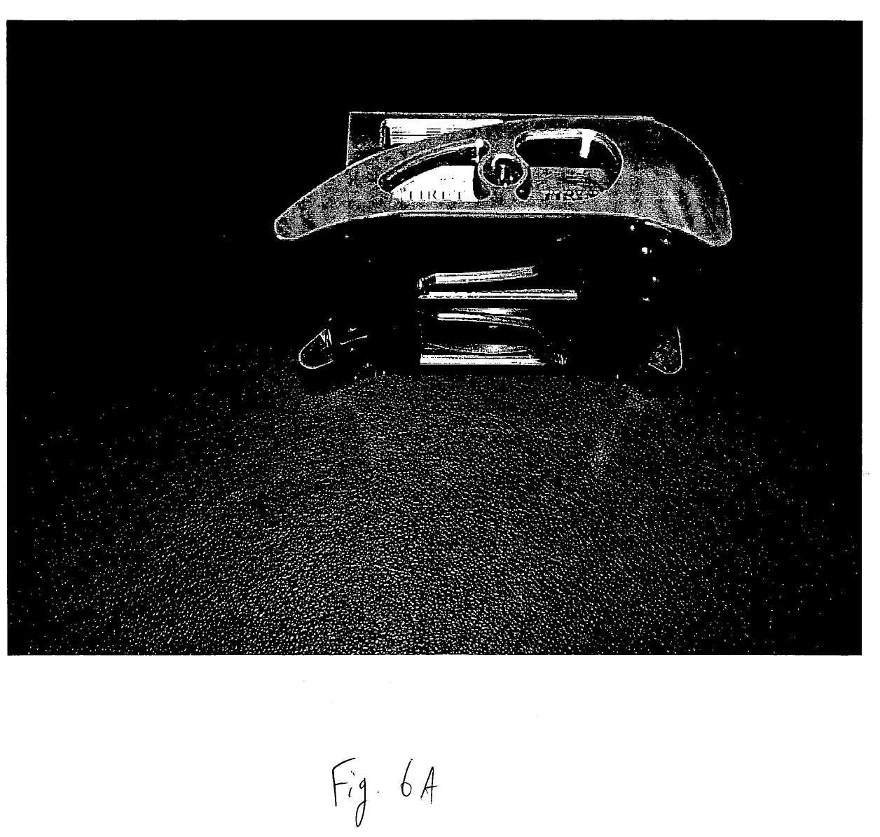

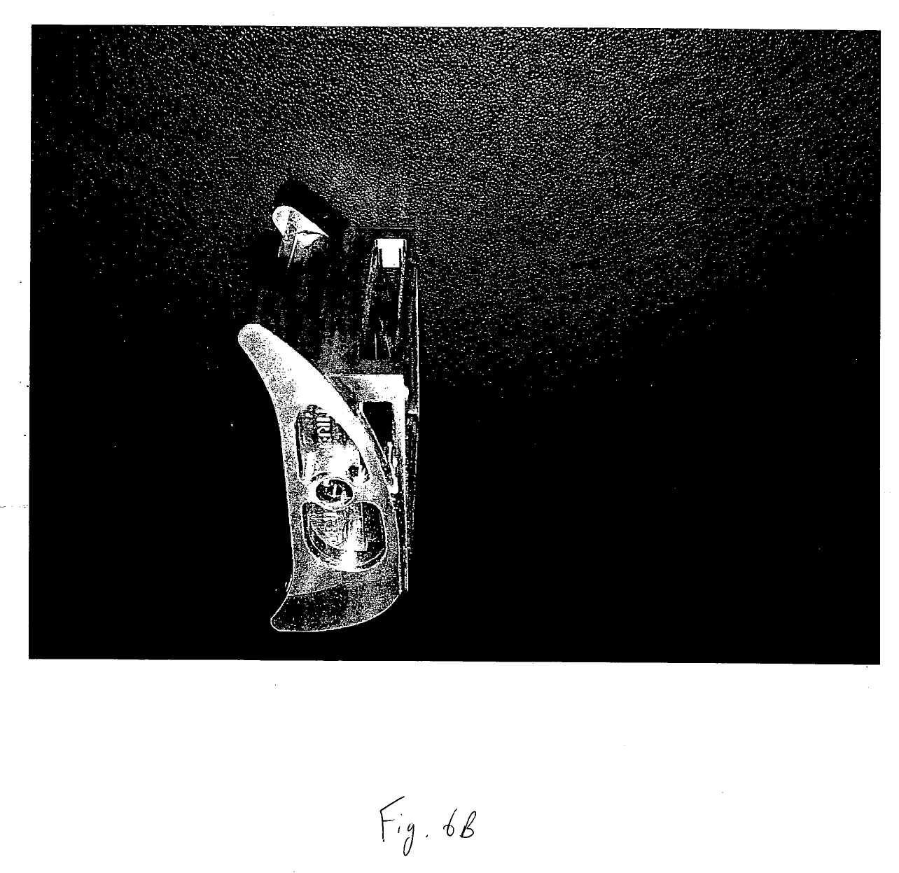

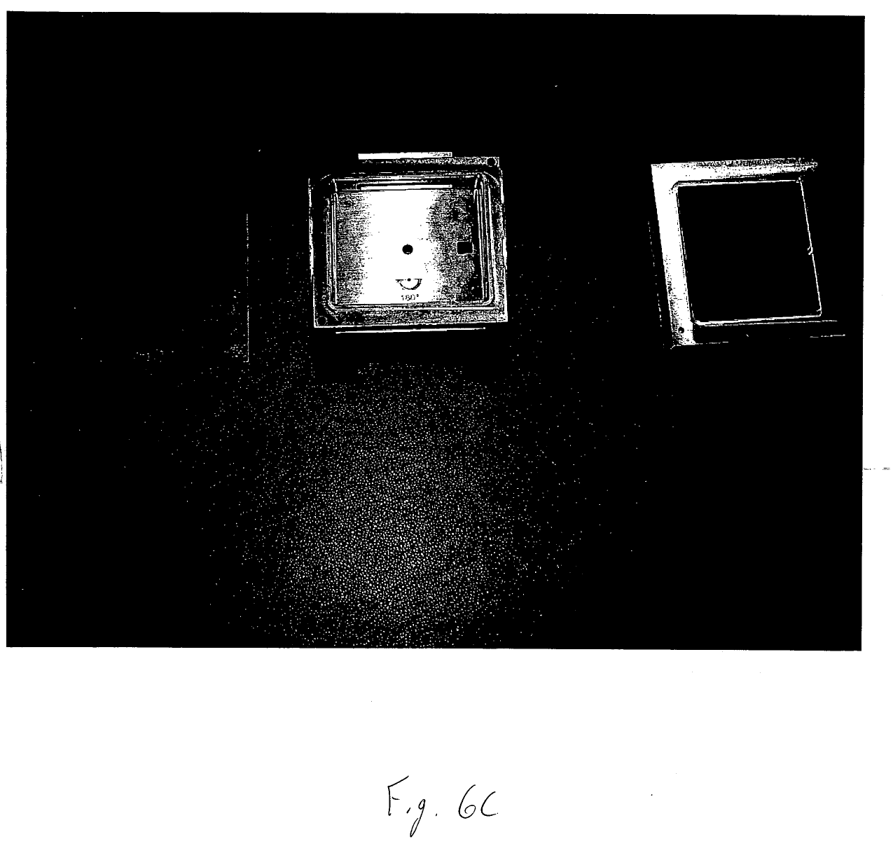

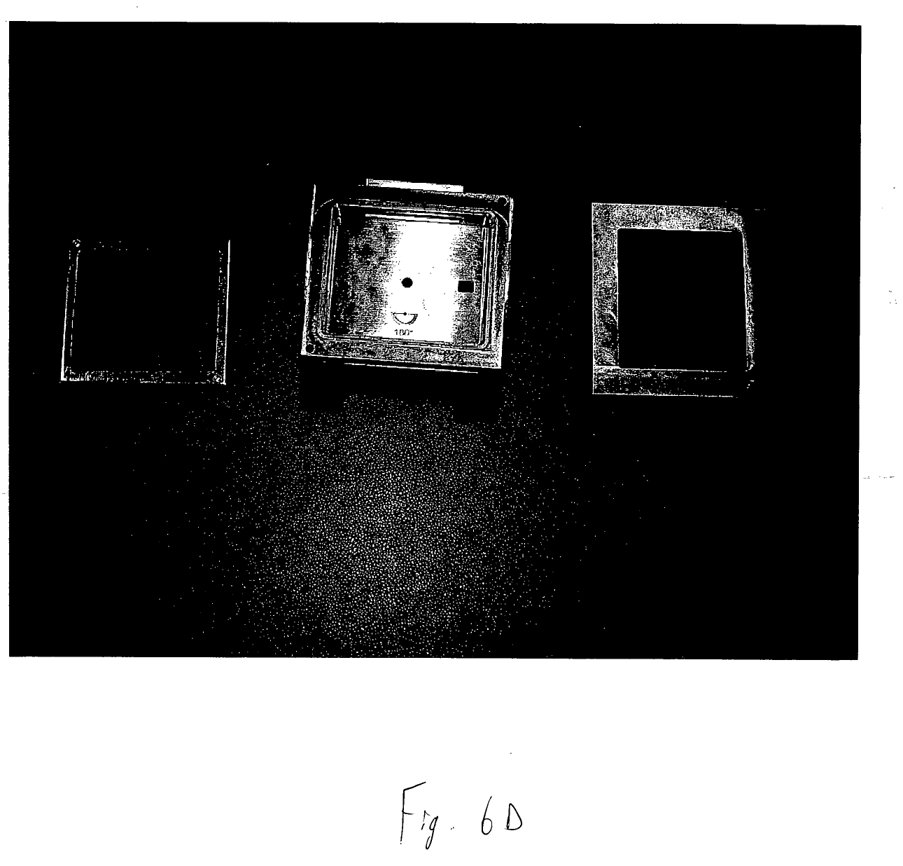

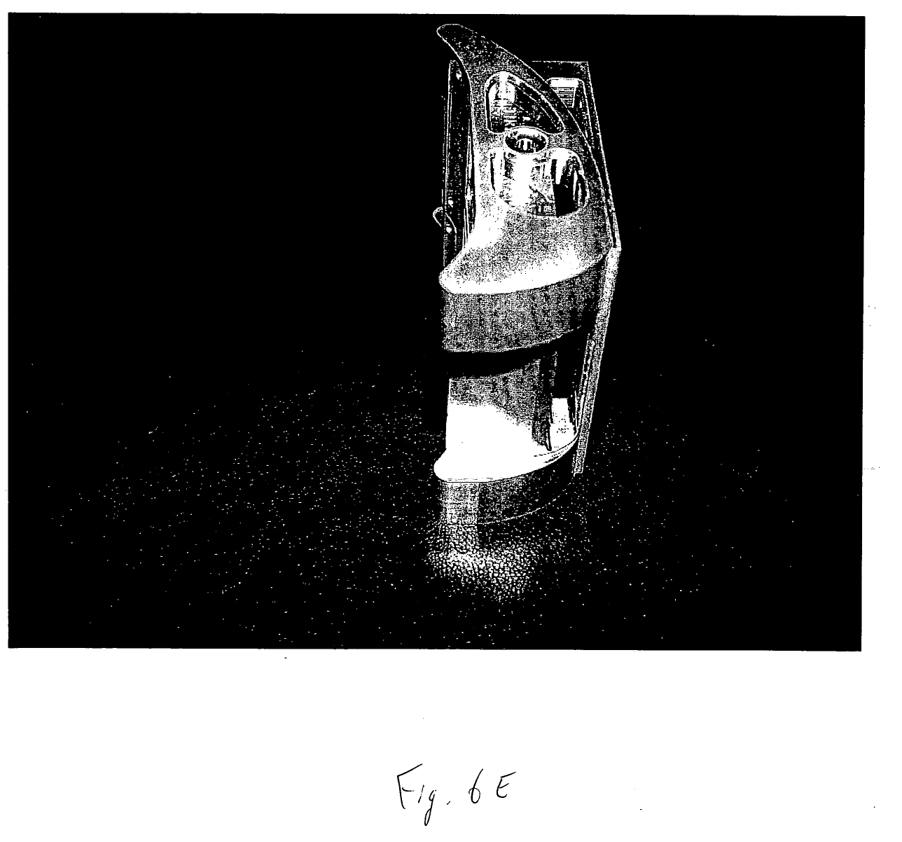

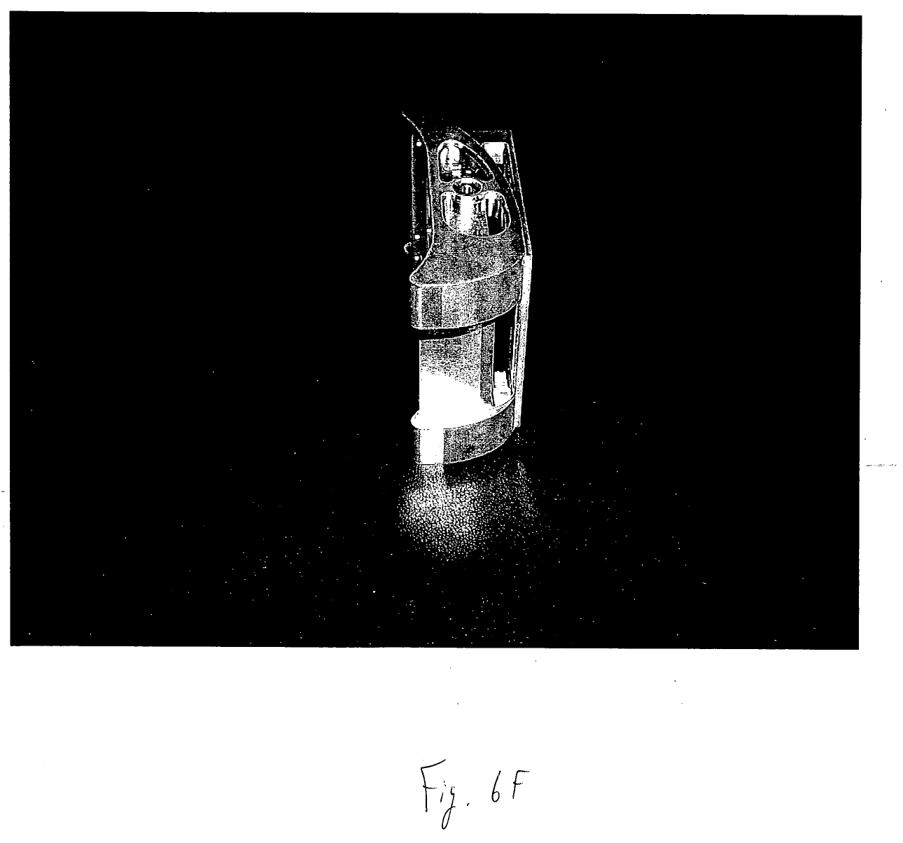

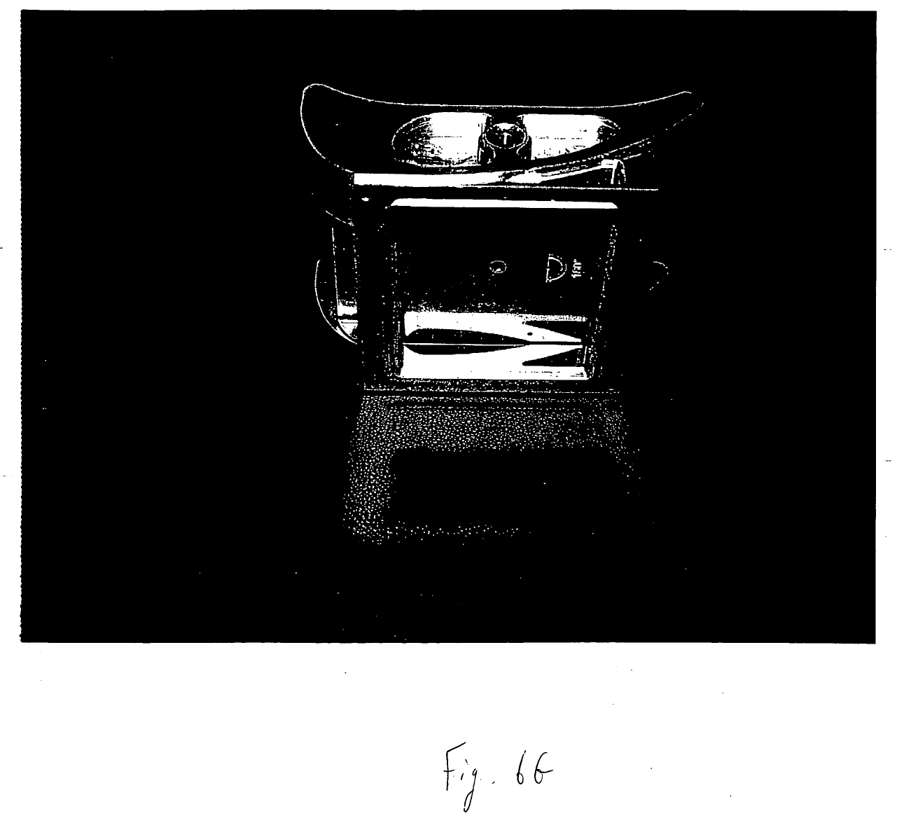

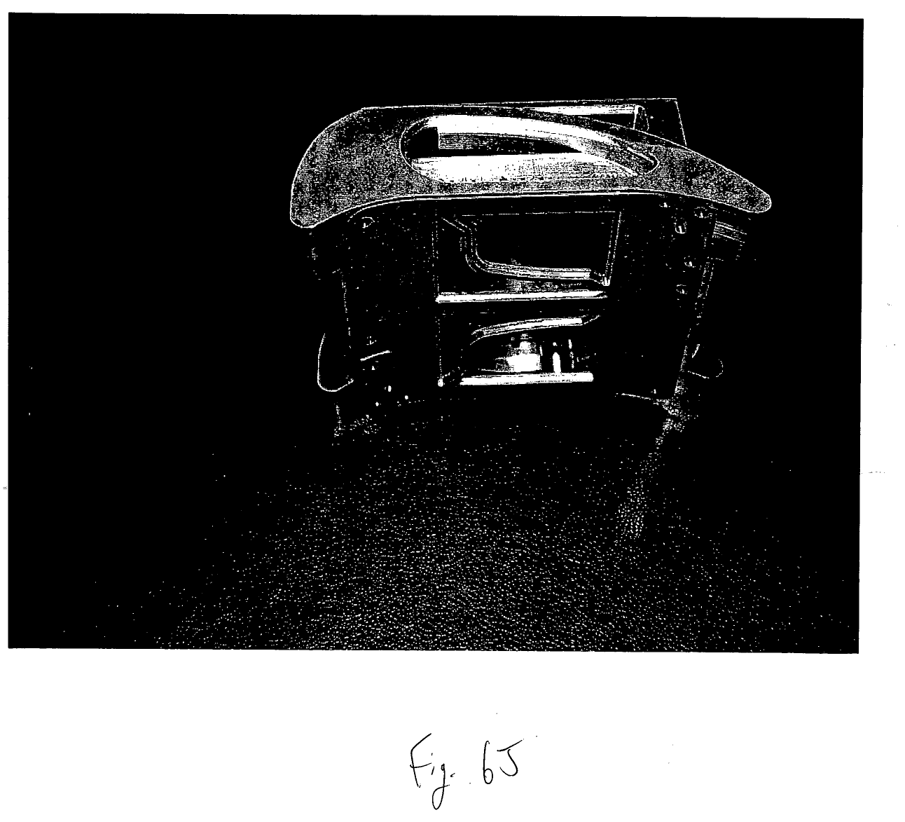

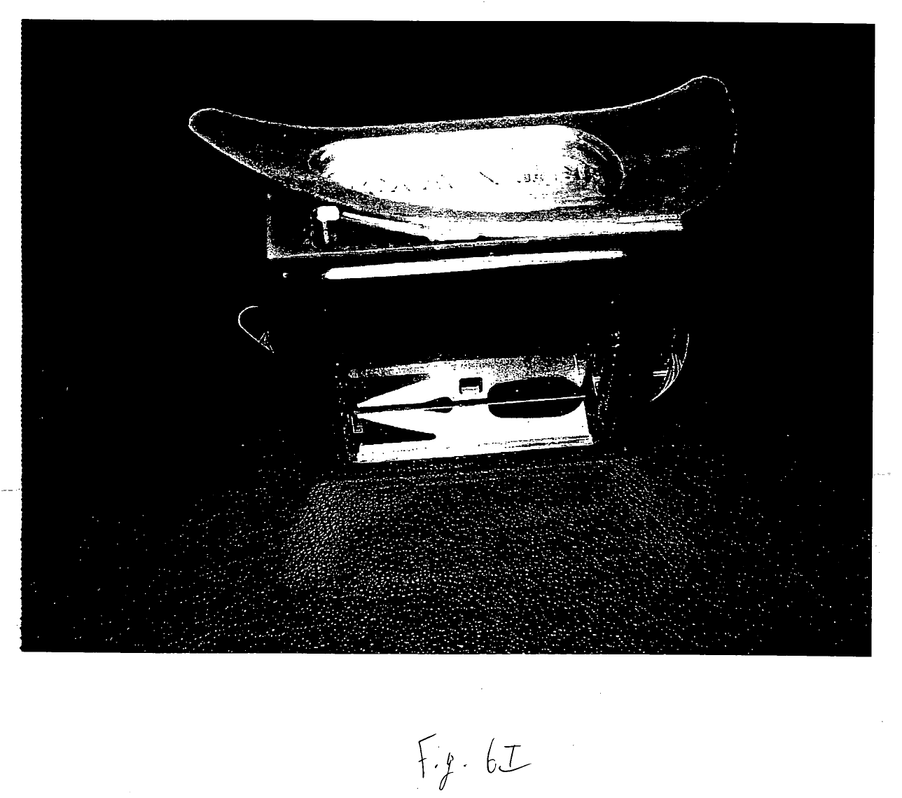

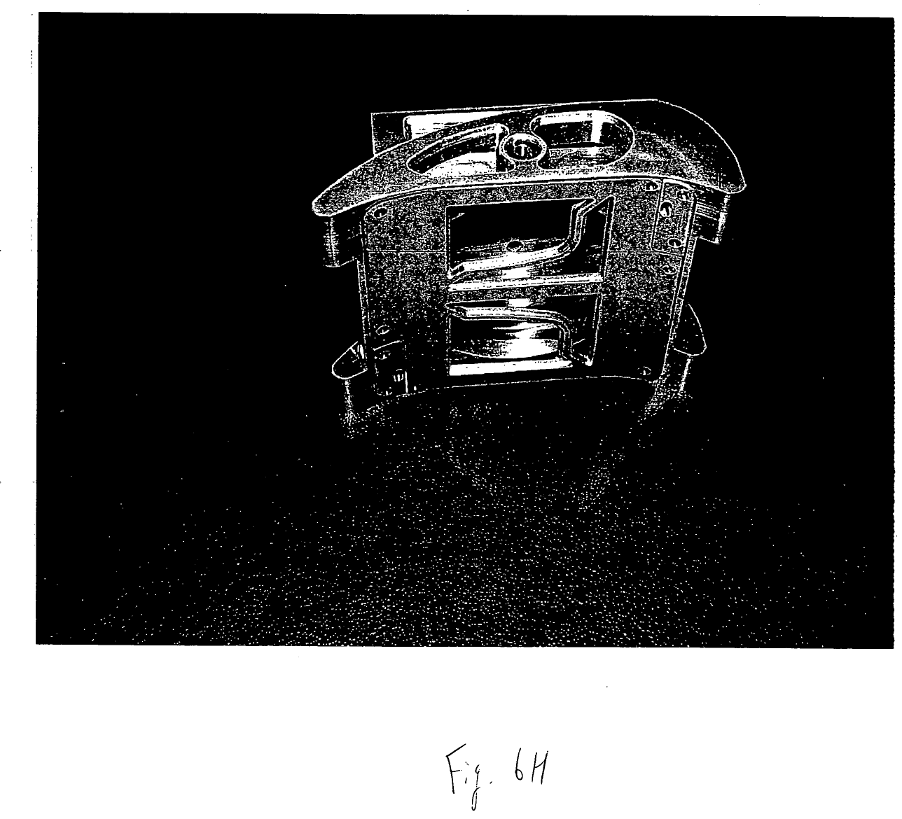

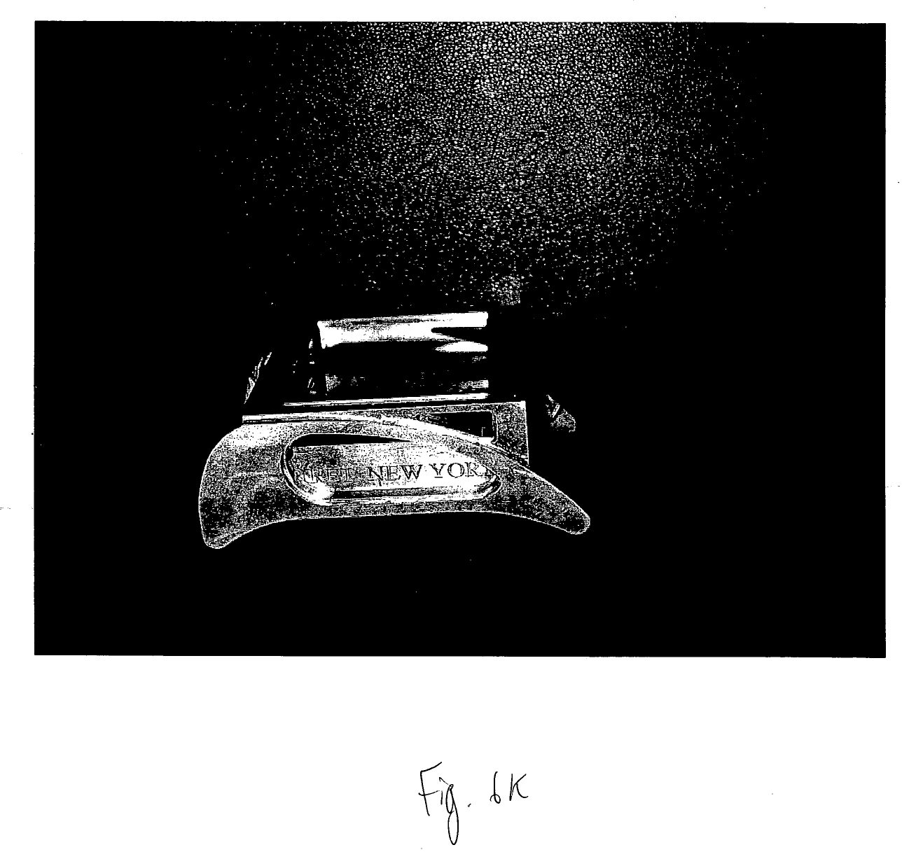

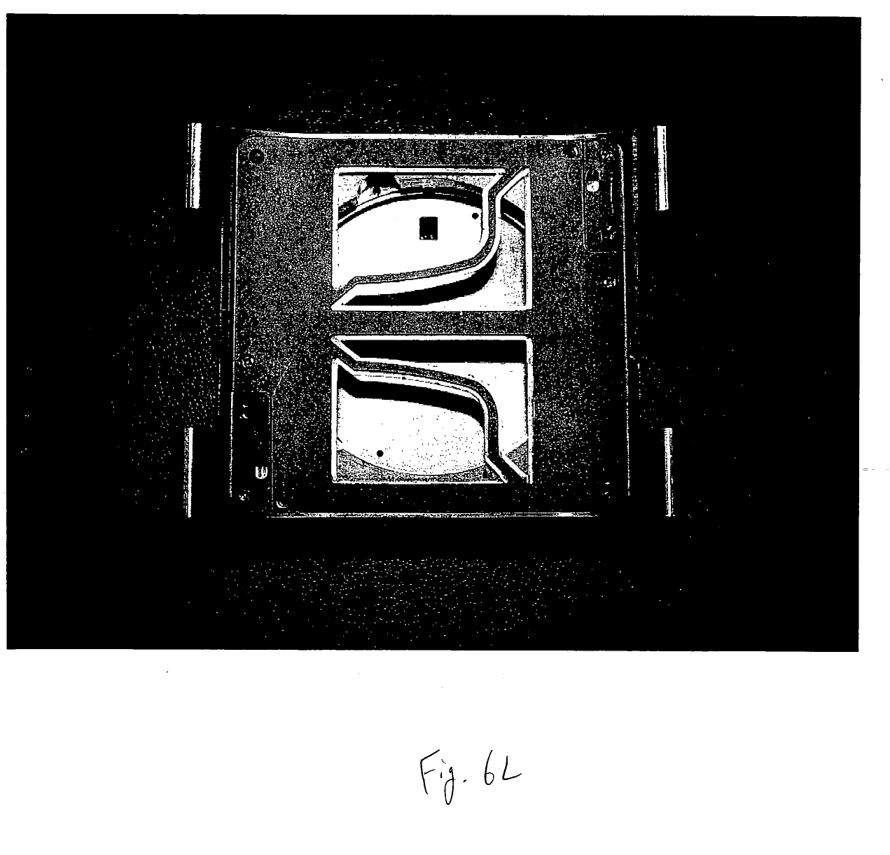

FIG. 6A shows a right elevational view of a preferred embodiment, and 6B illustrates a right perspective view of the preferred embodiment shown in FIG. 6A. FIG. 6C is a front elevational view of the embodiment shown in FIG. 6A, and further illustrates a detached view of the square bezel. FIG. 6D is another front elevational view of the embodiment shown in FIG. 6A, and further illustrates a detached view of the square bezel. FIGS. 6E-6L illustrate the embodiment shown in FIG. 6A, and include various perspectives and angles, as will be apparent to one skilled in the art.

Although the present invention has been described in relation to particular embodiments thereof, many other variations and modifications and other uses will become apparent to those skilled in the art. It is preferred, therefore, that the present invention be limited not by the specific disclosure herein.

What is claimed is:

1. A timepiece, comprising:
a substantially square-shaped dial face having a boundary surrounding the dial face;
a single series of hours indicia arranged along and following the boundary and surrounding an interior region of the dial face;
a time movement including respective hour and minute handles;
a detachable substantially square-shaped bezel; and
a plurality of windows that enable the viewing of the interior region of the dial face from respective viewing angles.
